(19) United States
(12) Patent Application Publication
(10) Pub. No.: US 2024/0427017 A1
(43) Pub. Date: Dec. 26, 2024

(54) Object Detection Method And System

(71) Applicants: Hyundai Motor Company, Seoul (KR); Kia Corporation, Seoul (KR)

(72) Inventor: Mi Rim Noh, Jeonju-si (KR)

(21) Appl. No.: 18/532,778

(22) Filed: Dec. 7, 2023

(30) Foreign Application Priority Data
Jun. 22, 2023 (KR) 10-2023-0080397

(51) Int. Cl. G01S 17/10; G01S 7/4861; G01S 17/89; G01S 17/931; G06T 7/70; G06T 9/20

(52) U.S. Cl. CPC G01S 17/10; G01S 7/4861; G01S 17/89; G01S 17/931; G06T 7/70; G06T 9/20; G06T 2207/10028; G06T 2207/20116

(57) ABSTRACT

Disclosed is an object detection method that drives an object detection system having a processor. The object detection method includes, based on detecting an object in a region of interest within a predetermined distance from a vehicle via a sensor of the vehicle, extracting, from points in a point cloud associated with the object, contour points of the object, determining a horizontal region of the contour segment, determining whether a point density condition is satisfied, determining that at least one of the first or second contour points is unrelated to the object, and removing one of the first contour point or the second contour point from the point cloud.

### CROSS-REFERENCE TO RELATED APPLICATION

This application claims the benefit of Korean Patent Application No. 10-2023-0080397, filed Jun. 22, 2023, which is hereby incorporated by reference as if fully set forth herein.

### TECHNICAL FIELD

The present disclosure relates to an object detection method and system, and more particularly to an object detection method and system capable of removing a noise point.

### BACKGROUND

For safe operation of autonomous driving of a vehicle, it is important to accurately recognize and identify an environment around the vehicle (e.g. an object adjacent to the vehicle).

Accordingly, a vehicle may be equipped with various sensor devices, such as a camera, radar, and/or lidar. The vehicle may employ technologies for detecting, tracking, and/or classifying objects around the vehicle based on sensor data obtained through the sensor devices.

With conventional contour point extraction technology, when noise is included at the contour of a vehicle, even a noise point may be included as a contour point, whereby the vehicle is determined to move in a lateral direction when controlling a nearby target object by a system, and therefore braking may be applied to the vehicle.

For example, one of the shortcomings of the conventional contour point extraction technology is that, if a dynamic object includes noise related to a lane or the ground or if the dynamic object includes noise related to a load in a vehicle when the conventional object detection method is used, the vehicle may be determined to move in a lateral direction.

### SUMMARY

Accordingly, the present disclosure is directed to an object detection method and system that substantially obviates one or more problems due to limitations and disadvantages of the related art.

It is an object of the present disclosure to provide an object detection method and system capable of removing a noise point using point distribution when extracting contour points in a region adjacent to a vehicle, thereby improving confidence in location of a lidar object.

Objects of the present disclosure are not limited to the aforementioned object, and other unmentioned objects and advantages of the present disclosure will be understood from the following description, and will become more apparent by embodiments of the present disclosure. In addition, it will be readily apparent that the objects and advantages of the present disclosure may be realized by the means and combinations thereof set forth in the claims.

According to one or more example embodiments of the present disclosure, an object detection method may include: based on detecting an object in a region of interest within a predetermined distance from a vehicle via a sensor of the vehicle, extracting, via a processor and from points in a point cloud associated with the object, contour points of the object; determining, via the processor, a horizontal region of a contour segment connecting a first contour point and a second contour point of the contour points; determining, via the processor and based on the determined horizontal region, whether a point density condition is satisfied; determining, based on the point density condition being satisfied, that at least one of the first contour point or the second contour point is unrelated to the object; and removing, from the point cloud, the at least one of the first contour point or the second contour point.

The first contour point may be a currently searched point. The second contour point may be a point to be searched after the first contour point.

The method may further include: determining, via the processor and based on the point density condition being satisfied, whether to remove, from the point cloud, the first contour point, which being currently searched; and removing, via the processor and based on the first contour point satisfying a noise signal condition, the first contour point from the point cloud.

The method may further include: determining, via the processor and based on the point density condition being satisfied, whether to remove the first contour point from the point cloud; and retaining, via the processor and based on the first contour point not satisfying a noise signal condition, the first contour point in the point cloud.

The method may further include: determining, via the processor and based on the contour segment, a first contour angle formed by a point preceding the first contour point, the first contour point, and the second contour point; and determining, via the processor and based on the contour segment, a second contour angle formed by the first contour point, the second contour point, and a point adjacent to the second contour point.

The method may further include: determining, via the processor and based on a comparison between the first contour angle and the second contour angle, that at least one of the first contour point or the second contour point is unrelated to the object.

The method may further include: removing, via the processor and based on the second contour angle being greater than the first contour angle, the first contour point from the point cloud.

The method may further include: removing, via the processor and based on the second contour angle being less than the first contour angle, the second contour point from the point cloud.

The method may further include: determining, via the processor and based on the horizontal region before the first contour point is removed, a spatial distribution of a first horizontal region; and determining, via the processor and based on the horizontal region after the first contour point is removed, a spatial distribution of a second horizontal region. Removing the at least one of the first contour point or the second contour point may include removing, via the processor and based on a quantity of sampling points extracted from the spatial distribution of the first horizontal region being less than a quantity of sampling points extracted from the spatial distribution of the second horizontal region, the first contour point from the point cloud.

The method may further include: restoring, via the processor and based on the quantity of the sampling points extracted from the spatial distribution of the first horizontal region being greater than the quantity of sampling points extracted from the spatial distribution of the second horizontal region, the removed first contour point to the point cloud.

According to one or more example embodiments, an object detection system may include: an interface configured to receive, from a lidar sensor of a vehicle, a point cloud associated with an object; and a processor communicatively or electrically connected to the interface. The processor may be configured to: based on detecting the object in a region of interest within a predetermined distance from the vehicle, extract, from points in the point cloud, contour points of the object; determine a horizontal region of a contour segment connecting a first contour point and a second contour point of the contour points; determine, based on the determined horizontal region, whether a point density condition is satisfied; determine, based on the point density condition being satisfied, that at least one of the first contour point or the second contour point is unrelated to the object; and remove, from the point cloud, the at least one of the first contour point or the second contour point.

The first contour point may be a currently searched point. The second contour point may be a point to be searched after the first contour point.

The processor may be further configured to: determine, based on the point density condition being satisfied, whether to remove, from the point cloud, the first contour point being currently searched; and remove, based on the first contour point satisfying a noise signal condition, the first contour point from the point cloud.

The processor may be further configured to: determine, based on the point density condition being satisfied, whether to remove the first contour point from the point cloud; and retain, based on the first contour point not satisfying a noise signal condition, the first contour point in the point cloud.

The processor may be further configured to: determine, based on the contour segment, a first contour angle formed by a point preceding the first contour point, the first contour point, and the second contour point; and determine, based on the contour segment, a second contour angle formed by the first contour point, the second contour point, and a point adjacent to the second contour point.

The processor may be further configured to: determine, based on a comparison between the first contour angle and the second contour angle, that at least one of the first contour point or the second contour point is unrelated to the object.

The processor may be further configured to remove, based on the second contour angle being greater than the first contour angle, the first contour point from the point cloud.

The processor may be further configured to remove, based on the second contour angle being less than the first contour angle, the second contour point from the point cloud.

The processor may be further configured to: determine, based on the horizontal region before the first contour point is removed, a spatial distribution of a first horizontal region; and determine, based on the horizontal region after the first contour point is removed, a spatial distribution of a second horizontal region. The processor may be configured to remove the at least one of the first contour point or the second contour point by removing, based on a quantity of sampling points extracted from the spatial distribution of the first horizontal region being less than a quantity of sampling points extracted from the spatial distribution of the second horizontal region, the first contour point from the point cloud.

The processor may be further configured to restore, based on the quantity of the sampling points extracted from the spatial distribution of the first horizontal region being greater than the quantity of sampling points extracted from the spatial distribution of the second horizontal region, the removed first contour point to the point cloud.

### BRIEF DESCRIPTION OF THE DRAWINGS

The accompanying drawings, which are included to provide a further understanding of the present disclosure and are incorporated in and constitute a part of this application, illustrate embodiment(s) of the present disclosure and together with the description serve to explain the principle of the present disclosure. In the drawings:

FIG. 1 is a block diagram of a vehicle according to an embodiment of the present disclosure;

FIG. 2 is a view illustrating a region of interest according to an embodiment of the present disclosure;

FIG. 3 is a view illustrating a horizontal region according to an embodiment of the present disclosure;

FIGS. 4A, 4B, 4C, 5A, 5B, 6A, 6B, 7A, and 7B are views illustrating a method of setting and determining a point to be deleted in accordance with an embodiment of the present disclosure;

FIG. 8 is a flowchart of an object detection method according to an embodiment of the present disclosure; and

FIGS. 9A, 9B, 10A, and 10B are views illustrating the results of comparison between a conventional object detection method and the object detection method according to the embodiment of the present disclosure.

### DETAILED DESCRIPTION

Throughout the specification, the same reference numerals refer to the same components. The specification does not describe all elements of embodiments, and omits matters that are common in the art to which the present disclosure pertains or that are redundant between embodiments. As used herein, the term “unit”, “module”, or “device” may be implemented in software or hardware, and in some embodiments, a plurality of “units”, “modules”, or “devices” may be implemented as a single component, or a single “unit”, “module”, or “device” may include a plurality of components.

Throughout the specification, when one part is said to be “connected” to another part, this includes direct connection as well as indirect connection, and indirect connections include connection over a wireless communication network.

In addition, when a certain part is said to “include” a certain component, this means that the part may further include other components, not that the part excludes other components, unless specifically stated to the contrary.

Terms such as first, second, etc. are used to distinguish one component from another, and the components are not limited by the terms.

A singular representation may include a plural representation unless it represents a definitely different meaning from the context.

The identification of steps is for convenience of description only, and the identification does not describe the order of the steps, and the steps may be performed in any order other than that specified unless the context clearly indicates a particular order.

Hereinafter, principles of operation and embodiments of the present disclosure will be described with reference to the accompanying drawings.

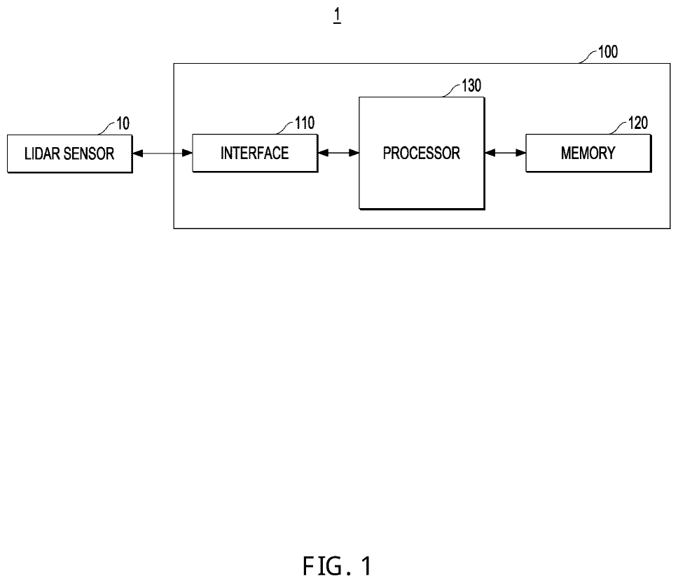

FIG. 1 is a block diagram of a vehicle according to an embodiment of the present disclosure.

Referring to FIG. 1, the vehicle 1 according to the embodiment of the present disclosure may include a lidar sensor 10 and an object detection system 100.

The lidar sensor 10 may be provided in one or plural, may be mounted outside a body of the vehicle 1, and may emit a laser pulse toward the periphery of the vehicle 1 to generate lidar data, i.e., a point cloud.

The object detection system 100 may include an interface 110, a memory 120, and/or a processor 130.

The interface 110 may transmit instructions or data input from another device of the vehicle 1, such as the lidar sensor 10, or a user, to another component of the object detection system 100, or may output instructions or data received from the other component of the object detection system 100 to the other device of the vehicle 1.

The interface 110 may include a communication module (not shown) to communicate with another device of the vehicle 1, such as the lidar sensor 10.

For example, the communication module may include a communication module capable of enabling communication between devices of the vehicle 1, such as controller area network (CAN) communication and/or local interconnect network (LIN) communication, over a communication network for vehicles. In addition, the communication module may include a wired communication module (e.g., a power line communication module) and/or a wireless communication module (e.g., a cellular communication module, a Wi-Fi communication module, a short-range wireless communication module, and/or a global navigation satellite system (GNSS) communication module).

The memory 120 may store various data used by at least one component of the object detection system 100, such as input data and/or output data for a software program and instructions associated therewith.

The memory 120 may include non-volatile memory such as cache, read only memory (ROM), programmable ROM (PROM), erasable programmable ROM (EPROM), electrically erasable programmable ROM (EEPROM), and/or flash memory, and/or volatile memory such as random access memory (RAM).

The processor 130 (also referred to as a control circuit or controller) may control at least one other component of the object detection system 100 (e.g., a hardware component (e.g., the interface 110 and/or the memory 120) and/or a software component (a software program)), and may perform various data processing and computations.

The processor 130 may preprocess and cluster a point cloud received from the lidar sensor 10. For example, the processor 130 may perform preprocessing on the point cloud and may cluster the preprocessed point cloud into meaningful geometric units, i.e., points of the parts that are expected to be the same object. That is, the processor 130 may create a cluster box.

For example, the processor 130 may cluster points for an object that is located in a region proximate to the vehicle 1, such as points for a neighboring vehicle, in the point cloud.

The processor 130 may set a region of interest (ROI) and may determine that an object condition is satisfied when the cluster box is located in the set region of interest. The processor 130 will be described in more detail later.

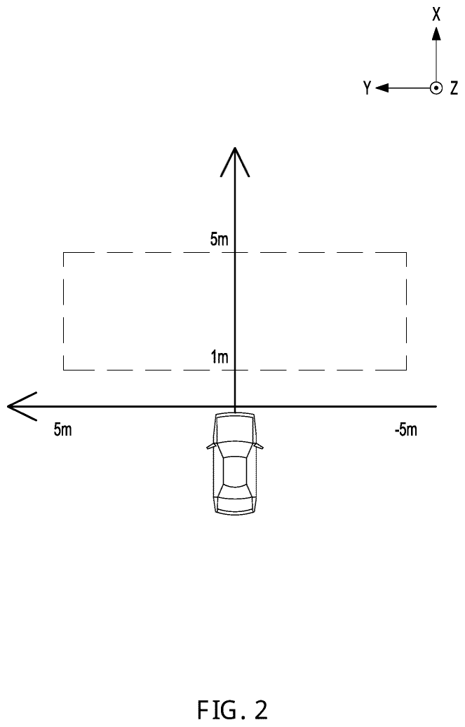

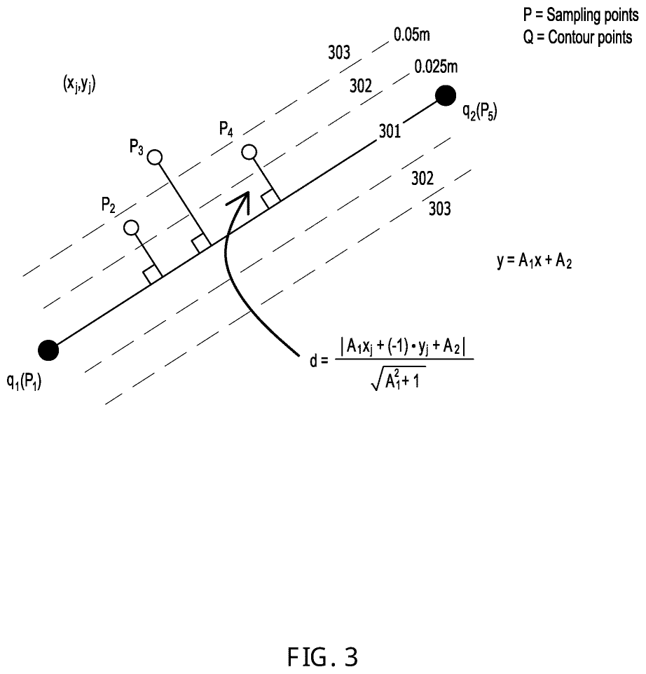

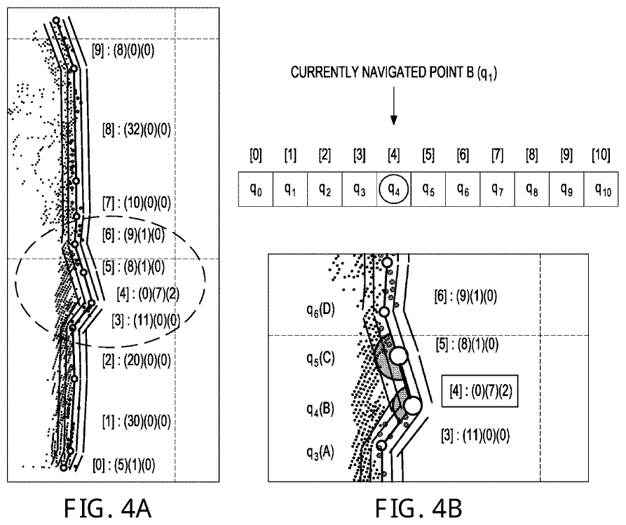

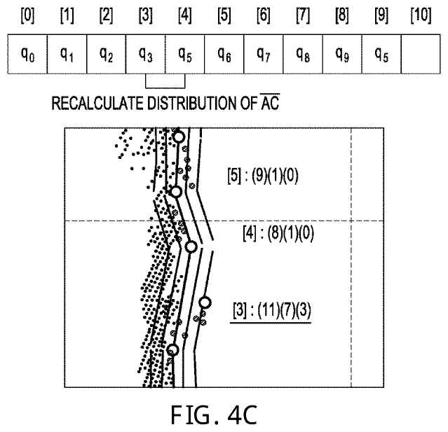

FIG. 2 is a view illustrating a region of interest according to an embodiment of the present disclosure. FIG. 3 is a view illustrating a horizontal region according to an embodiment of the present disclosure. FIGS. 4 to 7 are view illustrating a method of setting and determining a point to be deleted in accordance with an embodiment of the present disclosure.

As shown in FIG. 2, the processor 130 may set a region of interest (ROI) within a predetermined distance range from the vehicle 1. For example, the region of interest may be set to 1≤x≤5, −5≤Y≤5. The unit may be meters (m).

That is, the processor 130 may apply the location of the cluster box to objects that span within the region of interest.

As shown in FIG. 3, the processor 130 may calculate the distribution (e.g., spatial distribution) of a horizontal region of a contour segment when the object condition is satisfied.

When the object condition is satisfied, the processor 130 may extract points of the object from the point cloud, may extract representative points from the extracted points, and may extract contour points that may form a contour line of the object from the extracted representative points using a convex hull algorithm. Extraction of representative points and extraction of contour points are known, and therefore a detailed description thereof will be omitted.

The processor 130 may extract at least one sampling point P2, P3, and P4 necessary to form a horizontal region from extracted contour points q1(P1) and q2(P5) based on a contour segment connecting the extracted contour points. For example, the extracted contour points q1(P1) and q2(P5) may include a first contour point and a second contour point. For example, the contour segment may be defined as a segment connecting the first contour point q1(P1) and the second contour point q2(P5). The first contour point q1(P1) may be defined as a currently searched point, and the second contour point q2(P5) may be defined as a point to be searched after the currently searched point.

The contour segment connecting the extracted contour points described above may be sufficiently understood through a process of generating an outline (corresponding to a contour segment) consisting of effective outer points (corresponding to contour points) extracted from a prior document (Korean Patent Application Publication No. 10-2021-0124789), and therefore a detailed description thereof will be omitted.

The processor 130 may calculate the distance between the contour segment and at least one sampling point, and may set a horizontal region based on the calculated distance. Here, the distance may be calculated by Equation 1.

$$d = \frac{\vert {A}_{1} {x}_{j} + ( - 1 ) \cdot {y}_{j} + {A}_{2} \vert}{\sqrt{{A}_{1}^{2} + 1}} \qquad [ Mathematical expression 1 ]$$

d may be the distance between the contour segment and the sampling point. Each sampling point may be the shortest distance from the contour segment. The contour segment and the segment connecting each sampling point and the contour segment may be perpendicular to each other.

The horizontal region may divided by a predetermined interval based on the contour segment. The horizontal region may include a first region to a third region. Here, the predetermined interval may be approximately 0.025 m.

For example, the first region may be a region between 0.025 m and the contour segment in absolute value, the second region may be a region between 0.025 m and 0.05 m in absolute value, and the third region may be a region equal to or greater than 0.05 m in absolute value.

When the horizontal region of the contour segment is set, the processor 130 may analyze the point density based thereon, and may determine whether a point density condition is satisfied based on the analyzed result.

For example, when there is at least one of a plurality of sampling points in the third region of the horizontal region or when the ratio of sampling points distributed in the second region to sampling points distributed in the first and second regions of the horizontal region is approximately 20% or more, the processor 130 may determine that the point density condition is satisfied.

When the point density condition is satisfied, the processor 130 may determine whether to delete the first contour point, which is the currently searched point. For example, upon determining that a noise condition (e.g., a noise signal condition) is satisfied, the processor 130 may determine that the first contour point, which is the currently searched point, is a noise point and may delete the same. In contrast, upon determining that the noise condition is not satisfied, the processor 130 may not determine that the first contour point, which is the currently searched point, is a noise point and may retain the same. Noise may refer to signal noise. For example, noise may be any signal or data that is unwanted and/or irrelevant to the analysis (e.g., object analysis and/or identification). Noise may be any signal or data that is unrelated to the object.

As shown in FIG. 4A, when a horizontal region is set for each contour segment, the processor 130 may set a first contour segment connecting the second contour point and the first contour point, which is the currently searched point. FIG. 4B is an enlarged view of a part of FIG. 4A.

As shown in FIG. 4B, the first contour point may be set to point q4(B), and the second contour point may be set to point q5(C). Point q3(A), which is a point preceding the first contour point, may be a point that was searched before the currently searched point. Point q6(D), which is a point next to the second contour point, may be a point to be searched after the second contour point is searched.

The first contour segment connecting the first and second contour points may be a BC segment.

The processor 130 may set a first contour angle formed by point q3(A), the first contour point, and the second contour point based on the BC segment, and may set a second contour angle formed by the first contour point, the second contour point, and point q6(D) based on the BC segment. For example, the first contour angle may be referred to as an ABC angle, and the second contour angle may be referred to as a BCD angle.

When the first contour angle and the second contour angle are set, the processor 130 may compare the set first contour angle and the set second contour angle with each other to determine a noise point. For example, upon determining that the second contour angle is greater than the first contour angle, the processor 130 may determine that the BC segment including the first contour point protrudes due to noise. Accordingly, the processor 130 may delete the first contour point, which is the currently searched point.

As shown in FIG. 4C, the processor 130 may delete the first contour point, which is the currently searched point, may generate a second contour segment, which is a new contour segment connecting point q3(A) and the second contour point, and may calculate and store the distribution of the horizontal region for the second contour segment. Here, the second contour segment may be an AC segment.

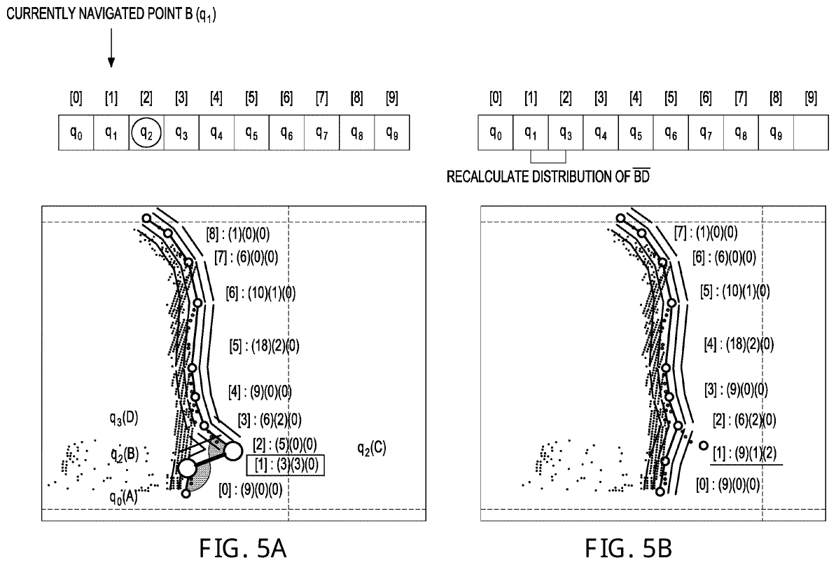

In contrast, as shown in FIG. 5A, when the horizontal region is set for each contour segment, the processor 130 may set a first contour segment connecting the second contour point and the first contour point, which is the currently searched point.

The first contour point may be set to point q1(B), and the second contour point may be set to point q2(C). Point q0(A), which is a point preceding the first contour point, may be a point that was searched before the currently searched point. Point q3(D), which is a point next to the second contour point, may be a point to be searched after the second contour point is searched.

The first contour segment connecting the first and second contour points may be a BC segment.

The processor 130 may set a first contour angle formed by point q0(A), the first contour point, and the second contour point based on the BC segment, and may set a second contour angle formed by the first contour point, the second contour point, and point q3(D) based on the BC segment. For example, the first contour angle may be referred to as an ABC angle, and the second contour angle may be referred to as a BCD angle.

When the first contour angle and the second contour angle are set, the processor 130 may compare the set first contour angle and the set second contour angle with each other to determine a noise point. For example, upon determining that the second contour angle is less than the first contour angle, the processor 130 may determine that the BC segment including the second contour point protrudes due to noise. Accordingly, the processor 130 may delete the second contour point, which is a point next to the first contour point, which is the currently searched point.

As shown in FIG. 5B, the processor 130 may delete the second contour point, which is a point next to the currently searched point, may generate a third contour segment, which is a new contour segment connecting the first contour point and point q3(D), and may calculate and store the distribution of the horizontal region for the third contour segment. Here, the third contour segment may be a BD segment.

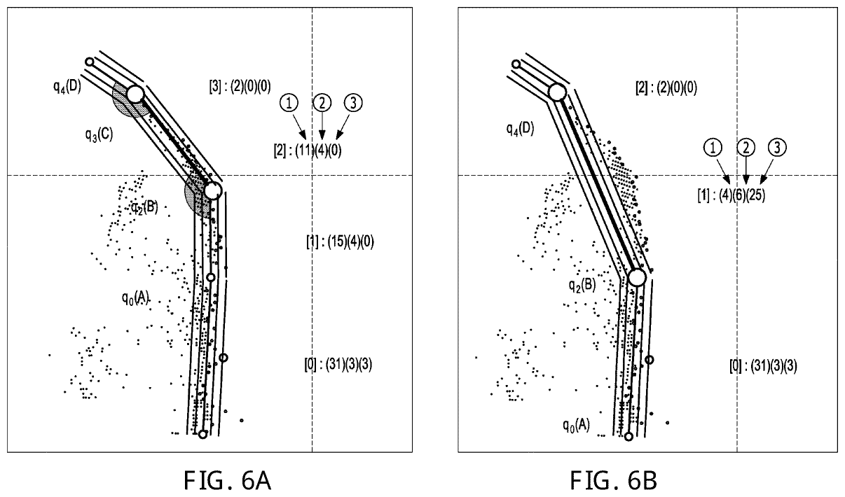

Subsequently, the processor 130 may finally determine the first contour point to be deleted or the second contour point to be deleted. The first contour point to be deleted will be described with reference to FIG. 6.

The processor 130 may finally determine whether to delete the first contour point to be deleted based on the distribution of the horizontal region.

As shown in FIG. 6, the processor 130 may compare and analyze the distribution of the horizontal region for the BC segment before the first contour point is deleted and the distribution of the horizontal region for the AC segment after the first contour point is deleted.

For convenience of description, the distribution of the horizontal region for the BC segment before the first contour point is deleted is called the distribution of a first horizontal region, and the distribution of the horizontal region for the AC segment after the first contour point is deleted is called the distribution of a second horizontal region.

The processor 130 may delete or restore the first contour point based on the result of comparison and analysis of the distribution of the horizontal region.

For example, when the distribution of the first region of the first horizontal region is lower than the distribution of the first region of the second horizontal region, the processor 130 may determine to finally delete the deleted first contour point. In contrast, when the distribution of the first region 301 of the first horizontal region is higher than the distribution of the first region 301 of the second horizontal region, the processor 130 may determine to restore the deleted first contour point. Here, higher distribution may mean a larger number of sampling points.

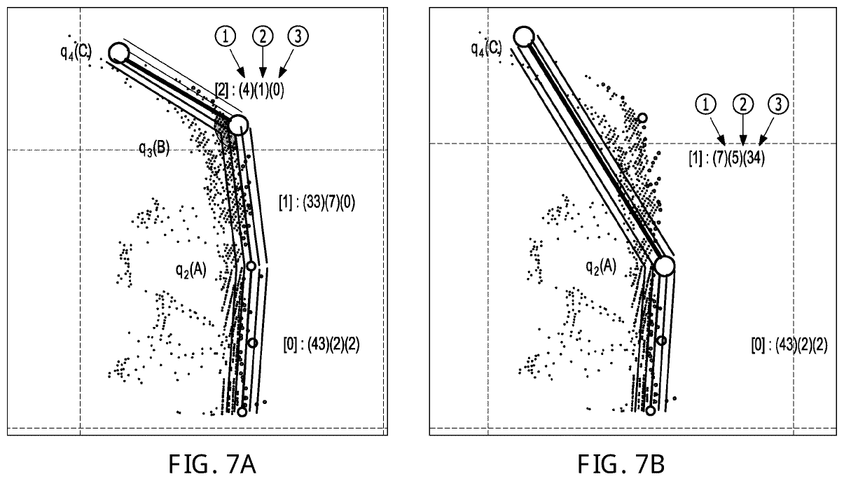

As shown in FIG. 7, when the number of sampling points present in the third region 303 of the second horizontal region is greater than the sum of the number of sampling points present in the first region 301 of the second horizontal region and the number of sampling points present in the second region 302 of the second horizontal region, the processor 130 may determine to restore the deleted first contour point. In contrast, when the number of sampling points present in the third region 303 of the second horizontal region is less than the sum of the number of sampling points present in the first region 301 of the second horizontal region and the number of sampling points present in the second region 302 of the second horizontal region, the processor 130 may determine to finally delete the deleted first contour point.

As described above, when the case in which the distribution of the first region 301 of the first horizontal region is higher than the distribution of the first region 301 of the second horizontal region and the case in which the number of sampling points present in the third region 303 of the second horizontal region is greater than the sum of the number of sampling points present in the first region 301 of the second horizontal region and the number of sampling points present in the second region 302 of the second horizontal region are satisfied, the processor 130 may determine to restore the deleted first contour point.

In contrast, when at least one of the case in which the distribution of the first region 301 of the first horizontal region is higher than the distribution of the first region 301 of the second horizontal region and the case in which the number of sampling points present in the third region 303 of the second horizontal region is greater than the sum of the number of sampling points present in the first region 301 of the second horizontal region and the number of sampling points present in the second region 302 of the second horizontal region is not satisfied, the processor 130 may determine to finally delete the deleted first contour point.

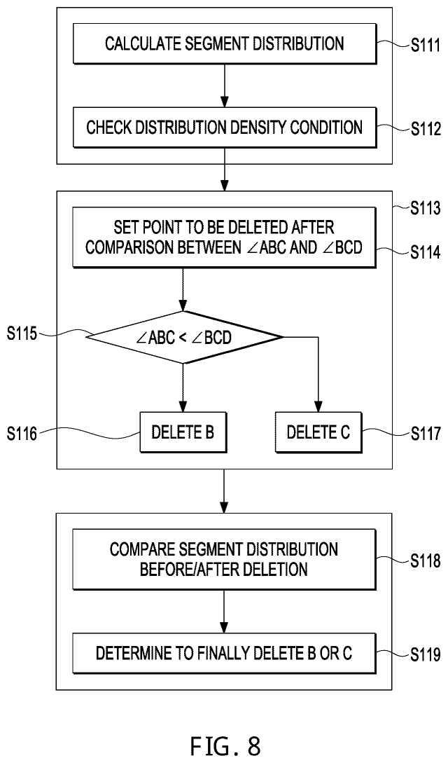

FIG. 8 is a flowchart of an object detection method according to an embodiment of the present disclosure.

Referring to FIG. 8, the flowchart of the object detection method according to the embodiment of the present disclosure is as follows.

The object detection system 100 may set a region of interest (ROI) under the control of the processor 130. For example, when a cluster box is located in the set region of interest, the object detection system 100 may determine that an object condition is satisfied under the control of the processor 130.

The object detection system 100 may set a region of interest (ROI) within a predetermined distance range from a vehicle 1 under the control of the processor 130. For example, the region of interest may be set to 1≤x≤5, −5≤y≤5. The unit may be meters (m).

That is, the object detection system 100 may be applied to an object in which the cluster box is located in the region of interest under the control of the processor 130.

When the object condition is satisfied, the object detection system 100 may calculate the distribution of a horizontal region of a contour segment under the control of the processor 130 (S111).

When the object condition is satisfied, the object detection system 100 may extract points of the object from a point cloud, may extract representative points from the extracted points, and may extract contour points that may form a contour line of the object from the extracted representative points using a convex hull algorithm under the control of the processor 130. Extraction of representative points and extraction of contour points are known, and therefore a detailed description thereof will be omitted.

The object detection system 100 may extract at least one sampling point P2, P3, and P4 necessary to form a horizontal region from extracted contour points q1(P1) and q2(P5) based on a contour segment connecting the extracted contour points under the control of the processor 130. For example, the extracted contour points q1(P1) and q2(P5) may include a first contour point and a second contour point.

For example, the contour segment may be defined as a segment connecting the first contour point q1(P1) and the second contour point q2(P5). The first contour point q1(P1) may be defined as a currently searched point, and the second contour point q2(P5) may be defined as a point to be searched after the currently searched point.

The contour segment connecting the extracted contour points described above may be sufficiently understood through a process of generating an outline (corresponding to a contour segment) consisting of effective outer points (corresponding to contour points) extracted from a prior document (Korean Patent Application Publication No. 10-2021-0124789), and therefore a detailed description thereof will be omitted.

The object detection system 100 may calculate the distance between the contour segment and at least one sampling point and may set a horizontal region based on the calculated distance under the control of the processor 130. Here, the distance may be calculated by Equation 1.

$$d = \frac{\vert {A}_{1} {x}_{j} + ( - 1 ) \cdot {y}_{j} + {A}_{2} \vert}{\sqrt{{A}_{1}^{2} + 1}} \qquad [ Mathematical expression 1 ]$$

d may be the distance between the contour segment and the sampling point. Each sampling point may be the shortest distance from the contour segment. The contour segment and the segment connecting each sampling point and the contour segment may be perpendicular to each other.

The horizontal region may be divided by a predetermined interval based on the contour segment. The horizontal region may include a first region to a third region. Here, the predetermined interval may be approximately 0.025 m.

For example, the first region may be a region between 0.025 m and the contour segment in absolute value, the second region may be a region between 0.025 m and 0.05 m in absolute value, and the third region may be a region equal to or greater than 0.05 m in absolute value.

When the horizontal region of the contour segment is set, the object detection system 100 may analyze the point density based thereon and may determine whether a point density condition is satisfied based on the analyzed result under the control of the processor 130 (S112).

For example, when there is at least one of a plurality of sampling points in the third region of the horizontal region or when the ratio of sampling points distributed in the second region to sampling points distributed in the first and second regions of the horizontal region is approximately 20% or more, the object detection system 100 may determine that the point density condition is satisfied under the control of the processor 130.

When the point density condition is satisfied, the object detection system 100 may determine whether to delete the first contour point, which is the currently searched point, under the control of the processor 130 (S113).

For example, upon determining that a noise condition is satisfied, the object detection system 100 may determine that the first contour point, which is the currently searched point, is a noise point under the control of the processor 130. In contrast, upon determining that the noise condition is not satisfied, the object detection system 100 may not determine that the first contour point, which is the currently searched point, is a noise point under the control of the processor 130.

When a horizontal region is set for each contour segment, the object detection system 100 may set a first contour segment connecting the second contour point and the first contour point, which is the currently searched point, under the control of the processor 130.

For example, referring to FIG. 4B, the first contour point may be set to point q4(B), and the second contour point may be set to point q5(C). Point q3(A), which is a point preceding the first contour point, may be a point that was searched before the currently searched point. Point q6(D), which is a point next to the second contour point, may be a point to be searched after the second contour point is searched.

The first contour segment connecting the first and second contour points may be a BC segment.

The object detection system 100 may set a first contour angle formed by point q3(A), the first contour point, and the second contour point based on the BC segment, and may set a second contour angle formed by the first contour point, the second contour point, and point q6(D) based on the BC segment, under the control of the processor 130. For example, the first contour angle may be referred to as an ABC angle, and the second contour angle may be referred to as a BCD angle.

When the first contour angle and the second contour angle are set (S114), the object detection system 100 may compare the set first contour angle and the set second contour angle with each other to determine a noise point under the control of the processor 130.

For example, upon determining that the second contour angle is greater than the first contour angle, the processor 130 may determine that the BC segment including the first contour point protrudes due to noise. Accordingly, the processor 130 may delete the first contour point, which is the currently searched point (S116).

Referring to FIG. 4C, the object detection system 100 may delete the first contour point, which is the currently searched point, may generate a second contour segment, which is a new contour segment connecting point q3(A) and the second contour point, and may calculate and store the distribution of the horizontal region for the second contour segment, under the control of the processor 130. Here, the second contour segment may be an AC segment.

Referring to FIG. 5A, when the horizontal region is set for each contour segment, the object detection system 100 may set a first contour segment connecting the second contour point and the first contour point, which is the currently searched point, under the control of the processor 130.

The first contour point may be set to point q1(B), and the second contour point may be set to point q2(C). Point q0(A), which is a point preceding the first contour point, may be a point that was searched before the currently searched point. Point q3(D), which is a point next to the second contour point, may be a point to be searched after the second contour point is searched.

The first contour segment connecting the first and second contour points may be a BC segment.

The object detection system 100 may set a first contour angle formed by point q0(A), the first contour point, and the second contour point based on the BC segment, and may set a second contour angle formed by the first contour point, the second contour point, and point q3(D) based on the BC segment, under the control of the processor 130. For example, the first contour angle may be referred to as an ABC angle, and the second contour angle may be referred to as a BCD angle.

When the first contour angle and the second contour angle are set, the object detection system 100 may compare the set first contour angle and the set second contour angle with each other to determine a noise point under the control of the processor 130. For example, upon determining that the second contour angle is less than the first contour angle, the processor 130 may determine that the BC segment including the second contour point protrudes due to noise. Accordingly, the processor 130 may delete the second contour point, which is a point next to the first contour point, which is the currently searched point.

Referring to FIG. 5B, the object detection system 100 may delete the second contour point, which is a point next to (e.g., adjacent to) the currently searched point, may generate a third contour segment, which is a new contour segment connecting the first contour point and point q3(D), and may calculate and store the distribution of the horizontal region for the third contour segment, under the control of the processor 130. Here, the third contour segment may be a BD segment.

The object detection system 100 may finally determine the first contour point to be deleted or the second contour point to be deleted under the control of the processor 130. The first contour point to be deleted will be described with reference to FIG. 6.

The object detection system 100 may finally determine whether to delete the first contour point to be deleted based on the distribution of the horizontal region under the control of the processor 130.

Referring to FIG. 6, the object detection system 100 may compare and analyze the distribution of the horizontal region for the BC segment before the first contour point is deleted and the distribution of the horizontal region for the AC segment after the first contour point is deleted under the control of the processor 130 (S118).

For convenience of description, the distribution of the horizontal region for the BC segment before the first contour point is deleted is called the distribution of a first horizontal region, and the distribution of the horizontal region for the AC segment after the first contour point is deleted is called the distribution of a second horizontal region.

The object detection system 100 may determine to delete or restore the first contour point based on the result of comparison and analysis of the distribution of the horizontal region under the control of the processor 130 (S118).

For example, when the distribution of the first region of the first horizontal region is lower than the distribution of the first region of the second horizontal region, the object detection system 100 may determine to finally delete the deleted first contour point under the control of the processor 130. In contrast, when the distribution of the first region 301 of the first horizontal region is higher than the distribution of the first region 301 of the second horizontal region, the processor 130 may determine to restore the deleted first contour point. Here, higher distribution may mean a larger number of sampling points.

Referring to FIG. 7, when the number of sampling points present in the third region 303 of the second horizontal region is greater than the sum of the number of sampling points present in the first region 301 of the second horizontal region and the number of sampling points present in the second region 302 of the second horizontal region, the object detection system 100 may determine to restore the deleted first contour point under the control of the processor 130. In contrast, when the number of sampling points present in the third region 303 of the second horizontal region is less than the sum of the number of sampling points present in the first region 301 of the second horizontal region and the number of sampling points present in the second region 302 of the second horizontal region, the processor 130 may determine to finally delete the deleted first contour point (S119).

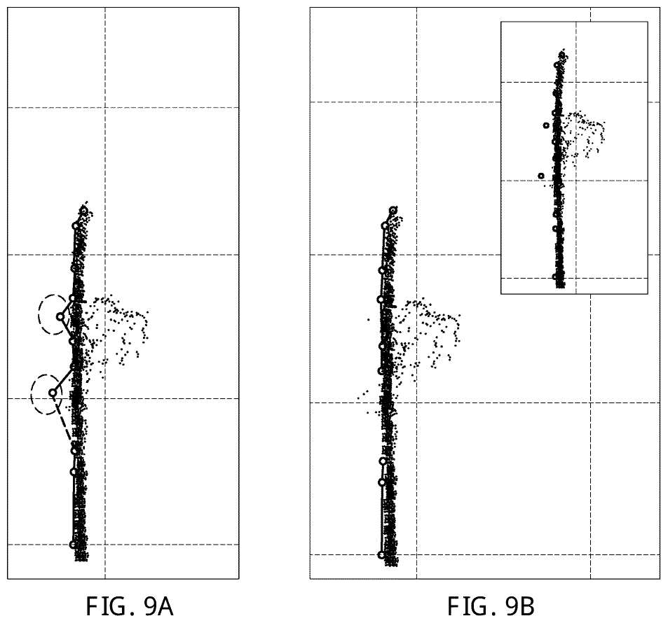

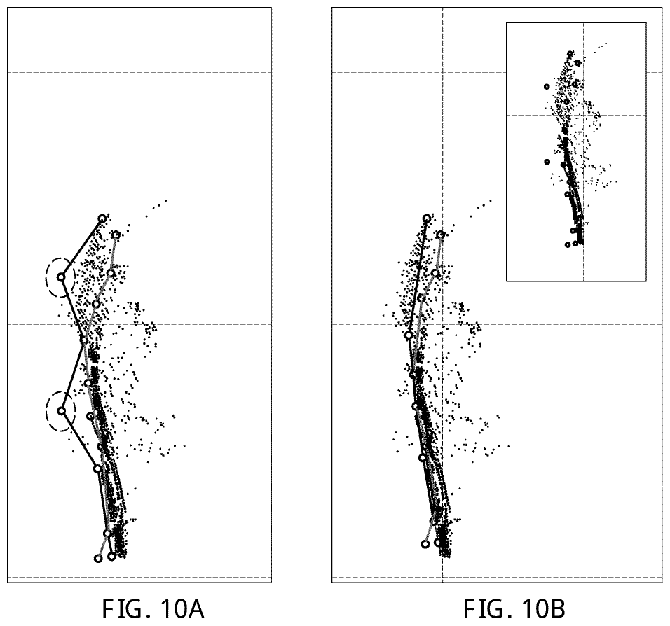

FIGS. 9 and 10 are views illustrating the results of comparison between a conventional object detection method and the object detection method according to the embodiment of the present disclosure.

The conventional object detection method may output the results shown in FIGS. 9A and 10A, and the object detection method according to the embodiment of the present disclosure may output the results shown in FIGS. 9B and 10B.

Referring to FIGS. 9A and 10A, when the conventional object detection method is used, there is a problem that, if a dynamic object includes noise related to a lane or the ground or if the dynamic object includes noise related to a load in a vehicle, the vehicle is determined to move in a lateral direction.

Referring to FIGS. 9B and 10B, the conventional problem shown in FIGS. 9A and 10A may be solved when the object detection method according to the embodiment of the present disclosure is used.

In the object detection method according to the embodiment of the present disclosure, as shown in FIGS. 9B and 10B, when contour points are extracted in a region adjacent to the vehicle, it is possible to remove a noise point using point distribution, whereby it is possible to improve confidence in location of a lidar object.

The above embodiments may be implemented in the form of a recording medium that stores computer-executable instructions. The instructions may be stored in the form of program code, and when executed by a processor, the instructions may generate a program module to perform the operations of the disclosed embodiments. The recording medium may be implemented as a computer-readable recording medium.

The computer-readable recording medium includes any type of recording medium that contains instructions that can be decoded by a computer. Examples of the computer-readable recording medium may include read only memory (ROM), random access memory (RAM), magnetic tape, magnetic disk, flash memory, and optical data storage.

As is apparent from the above description, an object detection method and system according to an embodiment of the present disclosure have the effect of removing a noise point using point distribution when extracting contour points in a region adjacent to a vehicle, thereby accurately detecting the location of a lidar object.

In addition, the object detection method and system according to the embodiment of the present disclosure have the effect of removing a noise point using point distribution when extracting contour points in a region adjacent to the vehicle, thereby improving confidence in location of a lidar object.

In addition, the object detection method and system according to the embodiment of the present disclosure have the effect of removing a noise point using point distribution when extracting contour points of a nearby object in a set region of interest (ROI), thereby improving confidence in location of a lidar object and thus contributing to improvement of system control performance.

The disclosed embodiments have been described above with reference to the accompanying drawings. A person having ordinary skill in the art to which the present disclosure pertains will understand that the present disclosure may be implemented in forms different from the disclosed embodiments without altering the technical ideas or essential features of the present disclosure. The disclosed embodiments are illustrative and should not be construed as being restrictive.

What is claimed is:

1. An object detection method comprising:
based on detecting an object in a region of interest within a predetermined distance from a vehicle via a sensor of the vehicle, extracting, via a processor and from points in a point cloud associated with the object, contour points of the object;
determining, via the processor, a horizontal region of a contour segment connecting a first contour point and a second contour point of the contour points;
determining, via the processor and based on the determined horizontal region, whether a point density condition is satisfied;
determining, based on the point density condition being satisfied, that at least one of the first contour point or the second contour point is unrelated to the object; and
removing, from the point cloud, the at least one of the first contour point or the second contour point.

2. The object detection method according to claim 1, wherein the first contour point is a currently searched point, and
wherein the second contour point is a point to be searched after the first contour point.

3. The object detection method according to claim 1, the method further comprising:
determining, via the processor and based on the point density condition being satisfied, whether to remove, from the point cloud, the first contour point, which being currently searched; and
removing, via the processor and based on the first contour point satisfying a noise signal condition, the first contour point from the point cloud.

4. The object detection method according to claim 1, the method further comprising:
determining, via the processor and based on the point density condition being satisfied, whether to remove the first contour point from the point cloud; and
retaining, via the processor and based on the first contour point not satisfying a noise signal condition, the first contour point in the point cloud.

5. The object detection method according to claim 1, the method further comprising:
determining, via the processor and based on the contour segment, a first contour angle formed by a point preceding the first contour point, the first contour point, and the second contour point; and
determining, via the processor and based on the contour segment, a second contour angle formed by the first contour point, the second contour point, and a point adjacent to the second contour point.

6. The object detection method according to claim 5, the method further comprising:
determining, via the processor and based on a comparison between the first contour angle and the second contour angle, that at least one of the first contour point or the second contour point is unrelated to the object.

7. The object detection method according to claim 6, the method further comprising:
removing, via the processor and based on the second contour angle being greater than the first contour angle, the first contour point from the point cloud.

8. The object detection method according to claim 6, the method further comprising:
removing, via the processor and based on the second contour angle being less than the first contour angle, the second contour point from the point cloud.

9. The object detection method according to claim 1, the method further comprising:
determining, via the processor and based on the horizontal region before the first contour point is removed, a spatial distribution of a first horizontal region; and
determining, via the processor and based on the horizontal region after the first contour point is removed, a spatial distribution of a second horizontal region,
wherein the removing of the at least one of the first contour point or the second contour point comprises removing, via the processor and based on a quantity of sampling points extracted from the spatial distribution of the first horizontal region being less than a quantity of sampling points extracted from the spatial distribution of the second horizontal region, the first contour point from the point cloud.

10. The object detection method according to claim 9, the method further comprising:
restoring, via the processor and based on the quantity of the sampling points extracted from the spatial distribution of the first horizontal region being greater than the quantity of sampling points extracted from the spatial distribution of the second horizontal region, the removed first contour point to the point cloud.

11. An object detection system comprising:
an interface configured to receive, from a lidar sensor of a vehicle, a point cloud associated with an object; and
a processor communicatively or electrically connected to the interface, wherein the processor is configured to:
based on detecting the object in a region of interest within a predetermined distance from the vehicle, extract, from points in the point cloud, contour points of the object;
determine a horizontal region of a contour segment connecting a first contour point and a second contour point of the contour points;
determine, based on the determined horizontal region, whether a point density condition is satisfied;
determine, based on the point density condition being satisfied, that at least one of the first contour point or the second contour point is unrelated to the object; and
remove, from the point cloud, the at least one of the first contour point or the second contour point.

12. The object detection system according to claim 11, wherein the first contour point is a currently searched point, and
wherein the second contour point is a point to be searched after the first contour point.

13. The object detection system according to claim 11, wherein the processor is further configured to:
determine, based on the point density condition being satisfied, whether to remove, from the point cloud, the first contour point being currently searched; and
remove, based on the first contour point satisfying a noise signal condition, the first contour point from the point cloud.

14. The object detection system according to claim 11, wherein the processor is further configured to:
determine, based on the point density condition being satisfied, whether to remove the first contour point from the point cloud; and
retain, based on the first contour point not satisfying a noise signal condition, the first contour point in the point cloud.

15. The object detection system according to claim 11, wherein the processor is further configured to:
determine, based on the contour segment, a first contour angle formed by a point preceding the first contour point, the first contour point, and the second contour point; and
determine, based on the contour segment, a second contour angle formed by the first contour point, the second contour point, and a point adjacent to the second contour point.

16. The object detection system according to claim 15, wherein the processor is further configured to:
determine, based on a comparison between the first contour angle and the second contour angle, that at least one of the first contour point or the second contour point is unrelated to the object.

17. The object detection system according to claim 16, wherein the processor is further configured to remove, based on the second contour angle being greater than the first contour angle, the first contour point from the point cloud.

18. The object detection system according to claim 16, wherein the processor is further configured to remove, based on the second contour angle being less than the first contour angle, the second contour point from the point cloud.

19. The object detection system according to claim 11, wherein the processor is further configured to:
determine, based on the horizontal region before the first contour point is removed, a spatial distribution of a first horizontal region; and
determine, based on the horizontal region after the first contour point is removed, a spatial distribution of a second horizontal region,
wherein the processor is configured to remove the at least one of the first contour point or the second contour point by removing, based on a quantity of sampling points extracted from the spatial distribution of the first horizontal region being less than a quantity of sampling points extracted from the spatial distribution of the second horizontal region, the first contour point from the point cloud.

20. The object detection system according to claim 19, wherein the processor is further configured to restore, based on the quantity of the sampling points extracted from the spatial distribution of the first horizontal region being greater than the quantity of sampling points extracted from the spatial distribution of the second horizontal region, the removed first contour point to the point cloud.
